(19) United States
(12) Patent Application Publication
(10) Pub. No.: US 2025/0117842 A1
(43) Pub. Date: Apr. 10, 2025

(54) METHOD AND DEVICE FOR GIFTING TO USER ACCOUNT

(71) Applicant: KAKAO CORP., Jeju-si (KR)

(72) Inventor: Eun Ha KIM, Seongnam-si (KR)

(21) Appl. No.: 18/902,518

(22) Filed: Sep. 30, 2024

(30) Foreign Application Priority Data
Oct. 5, 2023 (KR) 10-2023-0132525

(51) Int. Cl. G06Q 30/0601

(52) U.S. Cl. CPC G06Q 30/0637; G06Q 30/0641

(57) ABSTRACT

A server includes a processor configured to receive a recipient designation input designating a plurality of user accounts as a recipient of a gift from a user terminal accessing with a purchaser account, determine, based on country information of the plurality of user accounts indicating a plurality of countries, a target country from among the plurality of countries, determine, from among the plurality of user accounts, a user account having country information indicating the determined target country as a recipient account, and transmit, to the user terminal, a display command for a screen that provides information of a product giftable to the determined recipient account.

### CROSS-REFERENCE TO RELATED APPLICATION

This application claims the benefit of Korean Patent Application No. 10-2023-0132525 filed on Oct. 5, 2023, in the Korean Intellectual Property Office, the entire disclosure of which is incorporated herein by reference for all purposes.

### BACKGROUND

### Technical Field

One or more embodiments relate to technology for gifting goods between user accounts.

### Description of the Related Art

Recently, with the development of mobile smart devices, use of an online platform service to communicate with other users via a network has increased. The online platform service for interaction with other users may include, as representative examples, a social networking service (SNS), which is an online platform for generating and consolidating social relationships through communication among users, information sharing, and expansion of personal connections, and an instant messaging service (IMS), which is an online platform for real-time content communication between two or more users. As user interactions through these mobile devices increase, online platform services support the provision of various services based on communication between multiple users, as well as chat services for everyday conversations with other users.

### BRIEF SUMMARY

According to an aspect, there is provided a method performed by a server, the method including receiving a recipient designation input designating a plurality of user accounts as a recipient of a gift from a user terminal accessing with a purchaser account, determining, based on country information of the plurality of user accounts indicating a plurality of countries, a target country from among the plurality of countries, determining, from among the plurality of user accounts, a user account having country information indicating the determined target country as a recipient account, and transmitting, to the user terminal, a display command for a screen that provides information of a product giftable to the determined recipient account.

The determining of the target country from among the plurality of countries may include determining, based on the plurality of countries including a plurality of candidate countries available for a gift service, the target country from among the plurality of candidate countries by using a priority of the plurality of candidate countries.

The determining of the target country from among the plurality of countries may include determining, based on the plurality of countries including first countries available for a gift service and a second country unavailable for the gift service, the target country from among the first countries, wherein the method may further include transmitting, to the user terminal, a display command for a partial gifting enabled message notifying that, among a plurality of user accounts, gifting to a user account of the first countries is possible and gifting to a user account of the second country is not possible.

The method may further include skipping the determining of the target country, the determining of the recipient account, and the transmitting of the display command, based on all of the plurality of countries being unavailable for a gift service and transmitting, to the user terminal, a display command for a gifting impossible message indicating that gifting to the plurality of user accounts is not possible.

The transmitting of the display command for the screen to the user terminal may include transmitting the display command for the screen including information of a product available in the target country to the user terminal and excluding information of a product available in a country other than the target country from the screen.

The method may further include determining whether the plurality of countries includes another country available for a gift service, based on completion of gifting from the purchaser account to the recipient account and changing the target country to the another country based on the plurality of countries including the another country in which the gift service is available and repeating the determining of the user account as the recipient account and the transmitting of the display command based on the changed target country.

The method may further include receiving, from the user terminal, a product designation input designating a product to be gifted and comparing country information of a target product designated by the product designation input to the country information of the plurality of user accounts based on receiving the recipient designation input and the product designation input.

The method may further include allowing gifting the target product to the recipient account based on the country information of the target product indicating the target country and transmitting, to the user terminal, a display command for a notification message informing that the target product is not available in the target country, based on the country information of the target product indicating a country other than the target country.

The method may further include restricting gifting the target product to the recipient account based on the country information of the target product indicating a country other than the target country.

The method may further include transmitting, based on the country information of the target product indicating a different country from the target country, an approval request for receiving a gift of the target product available in the different country to a recipient terminal accessing with the recipient account, allowing gifting the target product to the recipient account based on receiving an approval response to the approval request from the recipient terminal, and restricting gifting the target product to the recipient account based on receiving a rejection response to the approval request from the recipient terminal.

According to another aspect, there is provided a server including a processor configured to receive a recipient designation input designating a plurality of user accounts as a recipient of a gift from a user terminal accessing with a purchaser account, determine, based on country information of the plurality of user accounts indicating a plurality of countries, a target country from among the plurality of countries, determine, from among the plurality of user accounts, a user account having country information indicating the determined target country as a recipient account, and transmit, to the user terminal, a display command for a screen that provides information of a product giftable to the determined recipient account.

The processor may be configured to determine, based on the plurality of countries including a plurality of candidate countries available for a gift service, the target country from among the plurality of candidate countries by using a priority of the plurality of candidate countries.

The processor may be configured to determine, based on the plurality of countries including first countries available for a gift service and a second country unavailable for the gift service, the target country from among the first countries and transmit, to the user terminal, a display command for a partial gifting enabled message notifying that, among a plurality of user accounts, gifting to a user account of the first countries is possible and gifting to a user account of the second country is not possible.

The processor may be configured to skip the determining of the target country, the determining of the recipient account, and the transmitting of the display command, based on all of the plurality of countries being unavailable for a gift service and transmit, to the user terminal, a display command for a gifting impossible message indicating that gifting to the plurality of user accounts is not possible.

The processor may be configured to transmit the display command for the screen including information of a product available in the target country to the user terminal and exclude information of a product available in a country other than the target country from the screen.

The processor may be configured to receive, from the user terminal, a product designation input designating a product to be gifted and compare country information of a target product designated by the product designation input to the country information of the plurality of user accounts based on receiving the recipient designation input and the product designation input.

The processor may be configured to allow gifting the target product to the recipient account based on the country information of the target product indicating the target country and transmit, to the user terminal, a display command for a notification message informing that the target product is not available in the target country, based on the country information of the target product indicating a country other than the target country.

The processor may be configured to restrict gifting the target product to the recipient account based on the country information of the target product indicating a country other than the target country.

The processor may be configured to transmit, based on the country information of the target product indicating a different country from the target country, an approval request for receiving a gift of the target product available in the different country to a recipient terminal accessing with the recipient account, allow gifting the target product to the recipient account based on receiving an approval response to the approval request from the recipient terminal, and restrict gifting the target product to the recipient account based on receiving a rejection response to the approval request from the recipient terminal.

Additional aspects of embodiments will be set forth in part in the description which follows and, in part, will be apparent from the description, or may be learned by practice of the disclosure.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 is a diagram illustrating an example of a gift system according to various embodiments;

FIG. 2 is a flowchart illustrating an example of a method of gifting to user accounts of a plurality of countries, according to various embodiments;

FIG. 3 is a diagram illustrating determining a target country when a plurality of countries includes a plurality of candidate countries available for a gift service, according to various embodiments;

FIG. 4 is a diagram illustrating determining a target country when a plurality of countries includes a country available for a gift service and a country unavailable for the gift service, according to various embodiments;

FIG. 5 is a diagram illustrating skipping determining of a target country when all of a plurality of countries are unavailable for a gift service, according to various embodiments;

FIG. 6 is a diagram illustrating an example of a screen that provides information of a product giftable to a recipient account, according to various embodiments;

FIG. 7 is a diagram illustrating an example of a screen that provides product information, according to various embodiments;

FIGS. 8A and 8B are diagrams illustrating an example of an operation in which an electronic device compares country information of a target product to country information of a plurality of user accounts, according to various embodiments; and

FIG. 9 is a drawing illustrating an example of a lookup screen for information on a target product gifted to a recipient account, according to various embodiments.

### DETAILED DESCRIPTION

The following structural or functional description of examples is provided as an example only and various alterations and modifications may be made to the examples. Thus, an actual form of implementation is not construed as limited to the examples described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

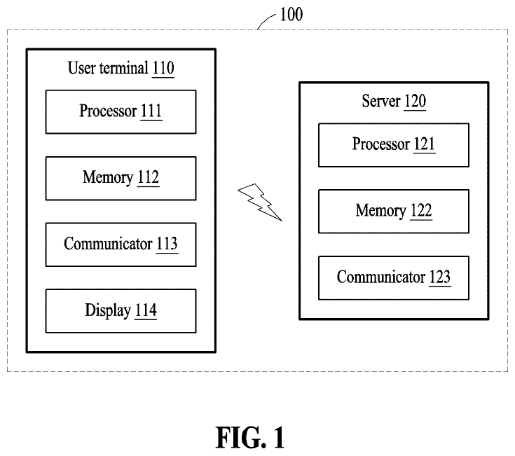

FIG. 1 is a diagram illustrating an example of a gift system according to various embodiments.

A gift system 100 according to an embodiment may include a user terminal 110 and a server 120.

The user terminal 110 may refer to one of electronic devices, such as a computer, a portable computer, a wireless phone, a mobile phone, a smartphone, a personal digital assistant (PDA), a web tablet, and any device that includes a display and that may install and execute a service application related to the server 120. Here, the user terminal 110 may perform overall service operations such as service screen configuration, data input, data transmission and reception, and data storage under the control of the application. For example, the user terminal 110 may access the server 120 through the application. For example, the user terminal 110 may use an instant messaging service (IMS) provided by the server 120.

The server 120 may provide a service to the user terminal 110. For example, the server 120 may provide an IMS or a social networking service (SNS). The server 120 may provide a gift service. According to an embodiment, the server 120 may include an instant messaging server (not shown) and a gift server (not shown). The instant messaging server may provide an IMS to the user terminal 110. The gift server may provide a gift service to the user terminal 110. The gift service may provide the user terminal 110 with a purchase of a product, sending of a product (e.g., gifting), receiving of a product (e.g., receiving a gift), and/or a refund of a product.

According to an embodiment, the gift server may provide a service of gifting a same product to each of a plurality of user accounts by designating the plurality of user accounts as a recipient of the gift. A gift server may provide a service for gifting a product to a gift recipient account having country information different from country information of a gift purchasing account. As described in more detail below, when a plurality of user accounts from a plurality of countries is designated as a recipient of a gift, the server 120 according to an embodiment may provide a service of gifting a product to at least one account among the plurality of user accounts.

A giftable item may include a digital coupon. A digital coupon may be used to prove authority over goods indicated by the digital coupon and may include, for example, a digital voucher and/or a digital certificate.

According to an embodiment, a product may be purchased by one user account and transmitted to another user account. For example, a digital coupon may be gifted by one user account to another user account. The another user account that has been gifted a digital coupon may consume the goods indicated by the digital coupon by presenting the digital coupon (or information on the digital coupon).

A type of digital coupon may include, for example, an item coupon and a voucher. A product coupon may refer to a digital coupon, wherein an entire digital coupon may be used at once as there may be an item (or service) corresponding to the goods indicated by the digital coupon, and the item (or the service) may have an indivisible property. A voucher may refer to a digital coupon that may be used at once or in multiple installments as there may be an asset corresponding to the goods indicated by the digital coupon and the asset may have a divisible property.

A user account is created when a user signs up for a service provided by the server 120, and the server 120 may serve as a service platform that provides a service to a user account registered for a service such as an SNS, an IMS, and the like. In various embodiments of the present disclosure, a user account may be primarily described as an account subscribing to an IMS. Since the user terminal 110 may use the service using a user account, the user account included in the following embodiments may be interpreted as corresponding to the user terminal 110.

According to an embodiment, the user terminal 110 may include a processor 111, a memory 112, a communicator 113, and a display 114.

The processor 111 may transmit, to the server 120, a recipient designation input designating one user account or a plurality of user accounts as a recipient of a gift. The processor 111 may receive, from the server 120, a display command for a screen that provides information of a product giftable to a determined recipient account from among a plurality of user accounts. The processor 111 may display the screen that provides information of a product giftable to the recipient account. The processor 111 may transmit, to the server 120, a product designation input designating a product to be gifted to the recipient account. The processor 111 may temporarily or permanently store, in the memory 112, data required for transmitting the recipient designation input, receiving the display command for the screen that provides information of a giftable product, displaying the screen that provides the information of a giftable product, and/or transmitting the product designation input.

The memory 112 may store information related to the recipient designation input, the display command for the screen that provides the information of a giftable product, the screen that provides the information of a giftable product, and/or the product designation input. The memory 112 may store commands for transmitting the recipient designation input, receiving the display command for the screen that provides the information of a giftable product, displaying the screen that provides the information of a giftable product, and/or transmitting the product designation input.

The communicator 113 may transmit at least one of the recipient designation input, the display command for the screen, or the product designation input. The communicator 113 may establish a wired communication channel and/or a wireless communication channel with an external apparatus (e.g., another electronic device or the server 120), and may establish communication via a long-range communication network, such as cellular communication, short-range wireless communication, local area network (LAN) communication, Bluetooth™, wireless-fidelity (Wi-Fi) direct or infrared data association (IrDA), a legacy cellular network, a fourth generation (4G) and/or fifth generation (5G) network, next-generation communication, the Internet, or a computer network (e.g., a LAN or a wide area network (WAN)).

The display 114 may visualize a screen and/or message providing giftable product information. The display 114 may be, for example, a touch display in which a touch sensing module and a display module are integrally implemented.

According to an embodiment, the server 120 may include a processor 121, a memory 122, and a communicator 123.

The processor 121 may receive a recipient designation input designating a plurality of user accounts as a recipient of a gift from the user terminal 110. The processor 121 may determine a target country from among a plurality of countries based on country information of a plurality of user accounts indicating a plurality of countries. The processor 121 may determine, from among the plurality of user accounts, a user account having country information indicating the target country as a recipient account. The processor 121 may transmit, to the user terminal 110, the display command for a screen that provides information of a product giftable to the recipient account. The processor 121 may also temporarily or permanently store, in memory, data required to perform receiving the recipient designation input, determining the target country, determining the recipient account, and/or transmitting the display command for a screen that provides information of a giftable product.

The memory 122 may store information on the recipient designation input, country information of the plurality of user accounts, the target country, the recipient account, and/or the screen that provides information of a giftable product. The memory 122 may store instructions for receiving the recipient designation input, determining the target country, determining the recipient account, and/or transmitting the display command for a screen that provides information of a giftable product.

The communicator 123 may transmit at least one of the recipient designation input, the display command for a screen, or the product designation input. The communicator 123 may establish a wired communication channel and/or a wireless communication channel with an external apparatus (e.g., the user terminal 110 or another electronic device), and may establish communication via a long-range communication network, such as cellular communication, short-range wireless communication, LAN communication, Bluetooth™, Wi-Fi direct or IrDA, a legacy cellular network, a 4G and/or 5G network, next-generation communication, the Internet, or a computer network (e.g., a LAN or a WAN).

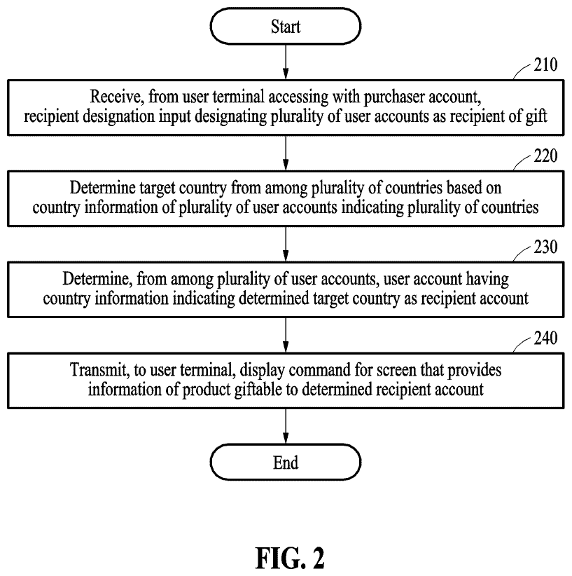

FIG. 2 is a flowchart illustrating an example of a method of gifting to user accounts of a plurality of countries, according to various embodiments.

When a plurality of user accounts of a plurality of countries is designated as a recipient of a gift, a server according to an embodiment (e.g., the server 120 of FIG. 1) may determine a target country from among the plurality of countries and may determine, from among the plurality of user accounts, a user account of the target country as a recipient account of the gift.

In operation 210, the server may receive, from a user terminal (e.g., the user terminal 110 of FIG. 1) accessing with a purchaser account, a recipient designation input designating the plurality of user accounts as the recipient of the gift. The purchaser account may be an account that has purchased (or will purchase) a product and may refer to a user account that gifts the product to another user account.

The recipient designation input may refer to an input that designates a user account (e.g., a user account different from the purchaser account) as the recipient of the gift. According to an embodiment, the user terminal may detect a user input designating the recipient of the gift from a user (e.g., a purchaser of the gift). In response to detecting the user input designating the recipient of the gift, the user terminal may transmit, to the server, the recipient designation input designating the user account designated by the user input as the recipient of the gift. The server may receive the recipient designation input from the user terminal.

According to an embodiment, the recipient designation input may designate a plurality of user accounts as a recipient of a gift. However, in various embodiments of the present disclosure, the recipient designation input is not limited to designating a plurality of user accounts. The recipient designation input may also designate one user account as the recipient of a gift.

In operation 220, the server may determine the target country from among the plurality of countries based on country information of the plurality of user accounts indicating the plurality of countries.

According to an embodiment, the server may look up country information of each of the plurality of user accounts. The server may obtain the country information of each of the plurality of user accounts by accessing an internal storage and/or an external storage that stores the country information of each of the plurality of user accounts.

The country information of a user account may refer to information indicating a country in which a user terminal corresponding to the user account is located or a country in which the user terminal is used. For example, the country information may include a country code of the user terminal corresponding to the user account. The country code of the user terminal may be obtained from a mobile phone number of the user terminal. The mobile phone number of the user terminal may include a country code. A country code may be used when calling a mobile terminal located in one country with a mobile terminal located in another country and may be a number consisting of a + sign and a minimum of one digit to a maximum of three digits according to the international telecommunication union telecommunication standardization sector (ITU-T) standard. For example, the country code for South Korea is +82, the country code for Japan is +81, and the country code for the United States and Canada is +1.

According to an embodiment, country information of a plurality of user accounts may indicate a plurality of countries. For example, among the plurality of user accounts, country information of a first user account may indicate a first country. Among the plurality of user accounts, country information of a second user account may indicate a second country. The first country may be different from the second country.

According to an embodiment, available products may vary from country to country. For example, a particular product may be available in the first country and may be unavailable in the second country that is different from the first country. When a purchaser account gifts a product that is only available in the first country to both the first user account and the second user account in the first country and the second country, an issue may occur that a product that is difficult to use is gifted to the second user account in the second country. As described in more detail below, the server according to an embodiment may induce the purchaser account to gift the recipient account a product that is available in the country of the recipient account or a product that is available in a country approved by the recipient account.

When the country information of the plurality of user accounts indicates the plurality of countries, the server may determine, from among the plurality of countries, a country available for a gift service as the target country. According to an embodiment, the server may determine the target country based on availability of each of the plurality of countries in the gift service. When it is possible for the purchaser account to purchase a product available in the first country through the gift service, that is, when the gift service supports purchase and/or transfer of the product available in the first country, the first country may be available for the gift service. When it is impossible for the purchaser account to purchase a product available in the second country through the gift service, that is, when the gift service does not support purchase and/or transfer of the product available in the second country, the second country may be unavailable for the gift service.

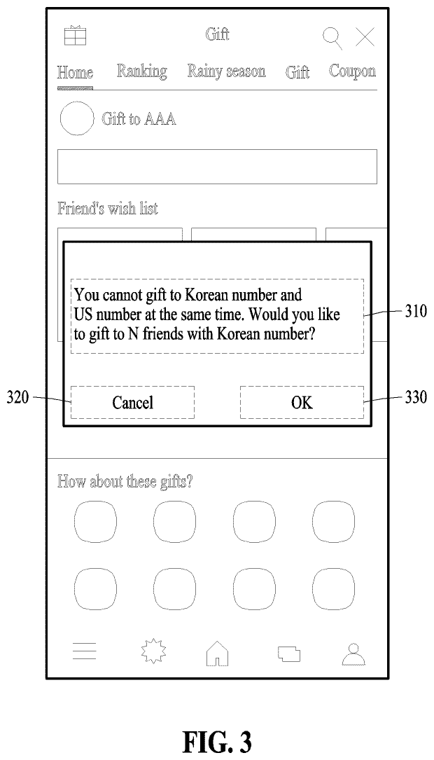

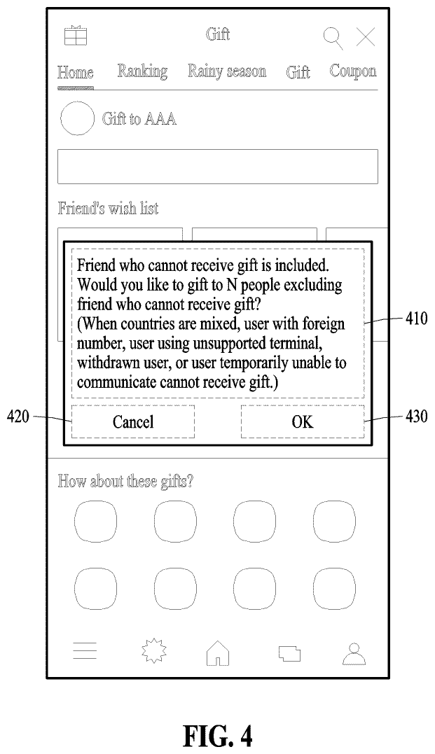

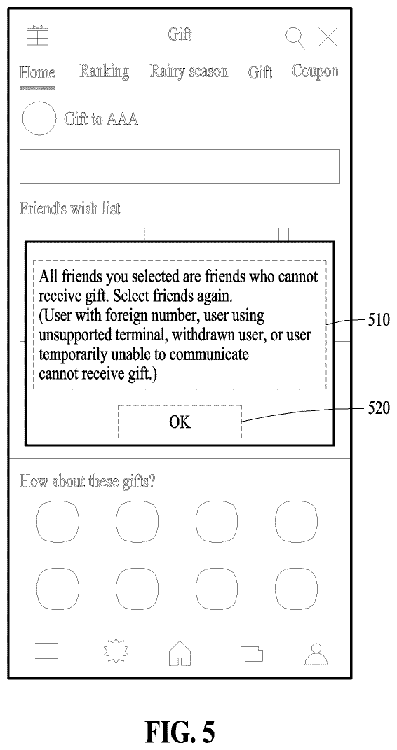

Determining of the target country in a case in which the plurality of countries includes a plurality of candidate countries available for the gift service is described in more detail below with reference to FIG. 3. Determining of the target country in a case in which the plurality of countries includes the first country available for the gift service and the second country unavailable for the gift service is described in more detail below with reference to FIG. 4. Skipping of determining the target country in a case in which all of the plurality of countries are unavailable for the gift service is described in more detail below with reference to FIG. 5.

In various embodiments of the present disclosure, the main description is of the case in which the country information of a user account designated based on a recipient designation input indicates the plurality of countries. However, embodiments are not limited thereto. For example, when the country information of a user account designated based on a recipient designation input indicates one country, and when that country is available for a gift service, that country may be determined to be the target country.

In operation 230, the server may determine, from among the plurality of user accounts, a user account having country information indicating the determined target country as a recipient account.

According to an embodiment, the server may determine at least one user account from among the plurality of user accounts as the recipient account based on the target country. The server may select, from among the plurality of user accounts, a user account of the target country as the recipient account. The server may exclude a user account of a country other than the target country, which is included among the plurality of user accounts, from the recipient account. As a result, the server may select, from among the plurality of user accounts of the plurality of countries designated by the recipient designation input, the user account of the target country as the recipient account and may induce the purchaser account to gift a product available in the target country to the recipient account.

In operation 240, the server may transmit, to the user terminal, a display command for a screen that provides information of a product giftable to the determined recipient account. The display command for the screen may include information necessary to display a screen that provides the information of a giftable product. The user terminal may receive, from the server, the display command for the screen that provides the information of the product giftable to the recipient account. The user terminal may, in response to the display command for the screen, display the screen that provides the information of the product giftable to the recipient account.

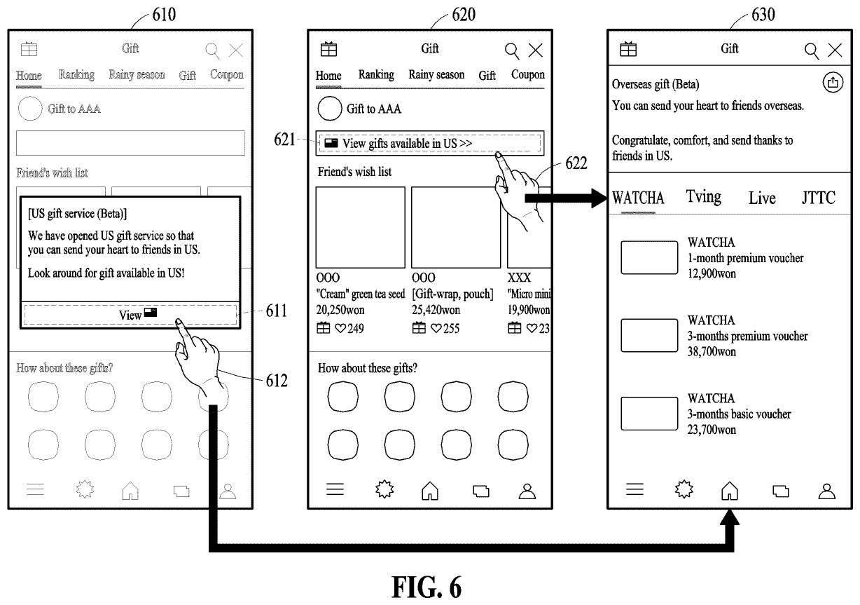

According to an embodiment, the screen that provides the information of the product giftable to the recipient account may include information on a product available in the target country only and exclude information on a product available in a country other than the target country. The screen providing giftable product information is described in more detail below with reference to FIG. 6.

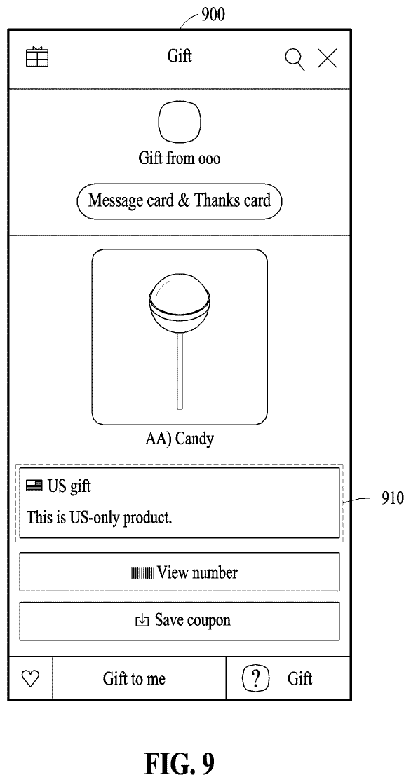

The server may obtain, from the user terminal, a product designation input designating a product to be gifted. The product designation input may refer to an input that designates a product to be transferred from the purchaser account to the recipient account. The user terminal may detect a user input for selecting a product through the screen that provides giftable product information and may transmit the product designation input to the server based on the user input for selecting a product. A target product may refer to a product designated by the product designation input. The server may allow gifting of the target product from the purchaser account to the recipient account based on the product designation input and the recipient designation input. For example, the server may request payment for the target product from the user terminal. The user terminal may make payment for the target product. The server may transfer the target product to each recipient account based on approval of payment for the target product. A user terminal (hereinafter, also referred to as a “recipient terminal”) accessing with the recipient account may look up information on the target product. The process of looking up information on the target product of the recipient account is described in more detail below with reference to FIG. 9.

Although not explicitly shown in FIG. 2, according to an embodiment, when gifting a user account in the target country, the server may gift a product to at least one of the plurality of user accounts by changing the target country and the recipient account.

The server may, based on completion of gifting from the purchaser account to the recipient account, determine whether the plurality of countries includes another country available for the gift service. The server may change the target country to the another country based on the plurality of countries including the another country available for the gift service and may repeat the determining of the user account as the recipient account and the transmitting of the display command based on the changed target country.

For example, the first user account in the first country and the second user account in the second country may be designated as recipients of a gift by the recipient designation input. The first country and the second country may be available for the gift service. The server may determine the first country as the target country and determine the first user account as the recipient account. Thereafter, through operations of the user terminal and/or the server, gifting from the purchaser account to the first user account may be completed. The server may change the target country to the second country based on the plurality of countries (e.g., the first country and the second country) including another country (e.g., the second country) available for the gift service and may determine the second user account as the recipient account based on the changed target country. Thereafter, through operations of the user terminal and/or the server, gifting from the purchaser account to the second user account may be completed.

When a plurality of user accounts of a plurality of countries is designated as recipients of a gift, the server according to an embodiment may gift all of the user accounts in the countries, among the plurality of countries, which are available for the gift service by repeating determining a target country and determining a recipient account.

FIG. 3 is a diagram illustrating determining a target country when a plurality of countries includes a plurality of candidate countries available for a gift service, according to various embodiments.

When a plurality of countries includes a plurality of candidate countries available for a gift service, a server (e.g., the server 120 of FIG. 1) may determine a target country from among the plurality of candidate countries.

According to an embodiment, the server may determine the target country from among the plurality of candidate countries by using a priority of the plurality of candidate countries. The server may map a predetermined priority to each of the countries available for the gift service. The server may determine a candidate country with a highest priority from among the plurality of candidate countries as the target country. For example, Korea and the United States may be countries available for the gift service. Korea may be mapped to a first rank, and the United States may be mapped to a second rank, which is lower than the first rank. When the plurality of countries includes Korea and the United States, the server may determine Korea as the target country since Korea has the highest priority among Korea and the United States.

According to an embodiment, the server may determine the target country based on a number of user accounts of each candidate country among a plurality of user accounts. The server may count, among the plurality of user accounts, the number of user accounts that have country information indicating each candidate country. The server may determine, from among the plurality of candidate countries, a candidate country having a greatest number of counted user accounts as the target country.

According to an embodiment, the server may determine the target country based on a user input for selecting one of the plurality of candidate countries. For example, the server may transmit, to the user terminal, a display command for a screen for selecting one of the plurality of candidate countries. The user terminal may display the screen for selecting one of the plurality of candidate countries. The user terminal may detect a user input for selecting one of the plurality of candidate countries. The user terminal may transmit, to the server, a target country designation input designating one of the plurality of candidate countries as the target country. When receiving the target country designation input from the user terminal, the server may determine the candidate country designated by the target country designation input as the target country.

According to an embodiment, the server may determine the target country based on country information of a target product designated by a product designation input. The server may determine, from among the plurality of candidate countries, a candidate country indicated by the country information of the target product as the target country.

As described above with reference to FIG. 2, the product designation input may refer to an input that designates a product to be transferred from a purchaser account to a recipient account. The product designation input may an input that precedes or follows receipt of a recipient designation input. In other words, the server may receive the recipient designation input and subsequently receive the product designation input, or may receive the product designation input and subsequently receive the recipient designation input. The target product may refer to the product designated by the product designation input. Country information of a product may include information indicating a country in which the product is available.

The server may transmit, to the user terminal, a display command for a message 310 which notifies that the plurality of countries designated by the recipient designation input includes a plurality of candidate countries and that a gift may be sent to a user account (e.g., the recipient account) of the target country among the plurality of user accounts. The user terminal may display the message 310 based on receiving the display command for the message 310 from the server.

According to an embodiment, the user terminal may further display, together with the message 310, an area 320 for a rejection and an area 330 for an approval of gifting to the user account (e.g., the recipient account) of the target country among the plurality of user accounts.

For example, when detecting a user input for the area 320, the user terminal may transmit, to the server, a rejection response for gifting to the user account (e.g., the recipient account) of the target country. The server may abort a gifting process for the user account (e.g., the recipient account) of the target country based on receiving the rejection response.

For example, when detecting a user input for the area 330, the user terminal may transmit, to the server, an approval response for gifting to the user account (e.g., the recipient account) of the target country. The server may proceed with the gifting process for the user account (e.g., the recipient account) of the target country based on receiving the approval response. The server may transmit, to the user terminal, a display command for a screen that provides information of a product giftable to the recipient account, based on the approval response. The user terminal may display the screen that provides the information of the product giftable to the recipient account, based on the display command for the screen.

FIG. 4 is a diagram illustrating determining a target country when a plurality of countries includes a country available for a gift service and a country unavailable for the gift service, according to various embodiments.

When a plurality of countries includes first country available for a gift service and a second country unavailable for the gift service, a server (e.g., the server 120 of FIG. 1) may determine a target country among the first country (or the first countries) and may transmit a display command for a partial gifting enabled message to a user terminal (e.g., the user terminal 110 of FIG. 1).

According to an embodiment, the server may determine the target country from among the first countries based on the plurality of countries including the first countries available for the gift service and the second countries unavailable for the gift service. The server may restrict determining of the second country, which is unavailable for the gift service, as the target country. For example, Korea and the United States may be available for the gift service and Japan may be unavailable for the gift service. When the plurality of countries includes Korea, the United States, and Japan, the server may determine the target country among Korea and the United States, which are available for the gift service. When the plurality of countries includes Korea and Japan, the server may determine Korea, which is available for the gift service, as the target country.

According to an embodiment, when the plurality of countries includes the first countries available for the gift service and the second country (or second countries) that is unavailable for the gift service, the server may determine the target country from among the first countries. As described above with reference to FIG. 3, the server may determine the target country among the first countries based on at least one of a priority, a number of user accounts, a target country designation input, or a product designation input.

According to an embodiment, the server may transmit, to the user terminal, a display command for a partial gifting enabled message 410 notifying that, among a plurality of user accounts, gifting to a user account of the first countries is possible and gifting to a user account of the second country is not possible. The user terminal may display the partial gifting enabled message 410 based on receiving the display command for the partial gifting enabled message 410 from the server.

According to an embodiment, the user terminal may further display, together with the partial gifting enabled message 410, an area 420 for a rejection and an area 430 for an approval of gifting to a user account (e.g., a recipient account) of the target country among the plurality of user accounts.

For example, when detecting a user input for the area 420, the user terminal may transmit, to the server, a rejection response for gifting to the user account (e.g., the recipient account) of the target country. The server may abort a gifting process for the user account (e.g., the recipient account) of the target country based on receiving the rejection response.

For example, when detecting a user input for the area 420, the user terminal may transmit, to the server, an approval response for gifting to the user account (e.g., the recipient account) of the target country. The server may proceed with the gifting process for the user account (e.g., the recipient account) of the target country based on receiving the approval response. The server may transmit, to the user terminal, a display command for a screen that provides information of a product giftable to the recipient account, based on the approval response. The user terminal may display the screen that provides the information of the product giftable to the recipient account, based on the display command for the screen.

FIG. 5 is a diagram illustrating skipping determining of a target country when all of a plurality of countries are unavailable for a gift service, according to various embodiments.

A server (e.g., the server 120 of FIG. 1) may skip determining the target country, determining the recipient account, and transmitting the display command, based on all of the plurality of countries being unavailable for the gift service.

When all of the plurality of countries are unavailable for the gift service, the server may determine that gifting is not possible for all of the plurality of user accounts. The server may abort a gifting process for the plurality of user accounts. The server may skip determining the target country, determining the recipient account, and transmitting the display command.

The server may transmit, to a user terminal, a display command for a gifting impossible message 510 indicating that gifting to the plurality of user accounts is not possible. The user terminal may display the gifting impossible message 510 based on receiving the display command for the gifting impossible message 510 from the server.

According to an embodiment, the user terminal may further include, along with the gifting impossible message 510, an area 520 for a confirmation of the gifting impossible message 510. When detecting a user input for the area 520, the user terminal may transmit a confirmation response for the gifting impossible message 510 to the server. The server may abort the gifting process for the plurality of user accounts based on receiving the confirmation response.

FIG. 6 is a diagram illustrating an example of a screen that provides information of a product giftable to a recipient account, according to various embodiments.

A server (e.g., the server 120 of FIG. 1) according to an embodiment may transmit a display command for a screen that includes information of a product available in a target country to a user terminal (e.g., the user terminal 110 of FIG. 1). The server may exclude information of a product available in a country other than the target country from the screen. For example, the server may transmit, to the user terminal, a display command for the screen from which the information of a product available in a country other than the target country is excluded. In another example, the server may instruct the user terminal to exclude information of a product available in other countries than the target country from the screen. The user terminal may display the screen that includes information of a product available in the target country. The user terminal may exclude the information of a product available in a country other than the target country from the screen. The screen may include information of a product available in the target country, and information of a product available in other countries may be excluded from the screen. In various embodiments of the present disclosure, the screen may also be referred to as a “a dedicated product screen corresponding to the target country.”

For example, the server may transmit, to the user terminal, a display command for an area (e.g., an area 611 and an area 621) for entering the dedicated product screen corresponding to the target country when the target country is different from a predetermined country. The user terminal may display the area (e.g., the area 611 and the area 621) for entering the dedicated product screen corresponding to the target country. For example, the predetermined country may be Korea, and the United States may be determined as the target country. The server may transmit, to the user terminal, a display command for an area for entering a dedicated product screen corresponding to the United States based on the United States being determined as the target country. The user terminal may display the area for entering the dedicated product screen corresponding to the United States. According to an embodiment, the server may provide a screen customized to country information of a recipient account by providing an entry point to a screen (e.g., a dedicated product screen) corresponding to a country (e.g., the target country) of the recipient account to receive a gift.

For example, when the target country is the predetermined country, the server may restrict transmitting of the display command for the area for entering the dedicated product screen corresponding to the target country to the user terminal. For example, the predetermined country may be Korea, and Korea may be determined as the target country. The server may not transmit a display command for an area for entering a dedicated product screen for Korea to the user terminal. The user terminal may not display the area for entering the dedicated product screen for Korea.

According to an embodiment, the server may determine a primary country of the recipient account of the gift service as the predetermined country, and may provide the dedicated product page only for other countries than the predetermined country. As a result, when a user account of the predetermined country is the recipient account, the server may provide product information so that entering a dedicated product page may not be necessary. When a user account of a country other than the predetermined country is the recipient account, the server may provide information of product available in the other country through a dedicated product page.

For example, as shown in a screen 610 of FIG. 6, the user terminal may display the area 611 for entering the dedicated product screen corresponding to the target country. The user terminal may transmit an entry request for the dedicated product screen to the server based on detecting a user input 612 for the area 611. The server may transmit a display command for the dedicated product screen corresponding to the target country to the user terminal based on the entry request for the dedicated product screen. The user terminal may display a dedicated product screen 630 corresponding to the target country based on receiving the display command for the dedicated product screen.

For example, as shown in a screen 620 of FIG. 6, the user terminal may display the area 621 for entering the dedicated product screen corresponding to the target country. The user terminal may transmit an entry request for the dedicated product screen to the server based on detecting a user input 622 for the area 621. The server may transmit the display command for the dedicated product screen corresponding to the target country to the user terminal based on the entry request for the dedicated product screen. The user terminal may display the dedicated product screen 630 corresponding to the target country based on receiving the display command for the dedicated product screen.

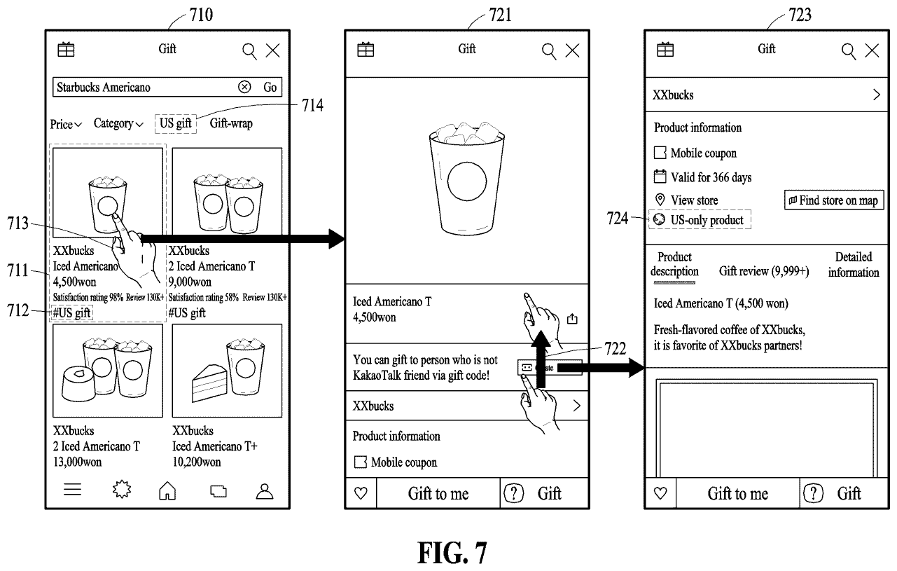

FIG. 7 is a diagram illustrating an example of a screen that provides product information, according to various embodiments.

A server (e.g., the server 120 of FIG. 1) according to an embodiment may obtain a product search request from a user terminal. The product search request may include, for example, at least one of a keyword, a brand, a category, or a theme.

The server may determine a product list including products obtained based on the product search request. The server may transmit, to the user terminal, a display command for a product list screen 710 showing a product list. The user terminal may display the product list screen 710. The product list screen 710 may include an area corresponding to each of a plurality of products of the product list. The user terminal may display at least one of a price of a product, an image of the product, or a brand of the product in an area 711 corresponding to the product. The user terminal may display a graphic object 712 corresponding to country information of the corresponding product in the area 711 corresponding to the product. As described above with reference to FIG. 3, country information of a product may indicate a country in which the product is available.

According to one embodiment, the product list screen 710 may include an area 714 for a filtering operation on country information. For example, when detecting a user input in the area 714, the user terminal may transmit a filtering input for country information to the server. When receiving the filtering input for country information from the user terminal, the server may determine a filtered product list including a product available in a country designated by the filtering input. The server may transmit a product list screen corresponding to the filtered product list to the user terminal. The user terminal may display the product list screen corresponding to the filtered product list. As a result, the user terminal may display a screen that provides information on a product having country information designated by the filtering input, for example, at least one of a price of the product, an image of the product, a brand of the product, or country information of the product).

A server according to an embodiment may determine whether to display a graphic object 712 corresponding to country information of a product based on whether the country information of the product indicates a predetermined country.

For example, when the country information of the product indicates a country (e.g., the United States) other than the predetermined country (e.g., Korea), the server may transmit a display command for the graphic object 712 corresponding to the country information of the product. When the country information of the product indicates a country (e.g., the United States) other than the predetermined country (e.g., Korea), the user terminal may display the graphic object 712 corresponding to the country information of the product in the area 711 corresponding to the product.

In another example, the server may restrict transmitting a display command for a graphic object corresponding to country information of a product when the country information of the product indicates the predetermined country (e.g., Korea). The user terminal may restrict displaying the graphic object corresponding to the country information of the product in an area corresponding to the product when the country information of the product indicates the predetermined country (e.g., Korea).

When detecting a user input 713 for selecting a product in an area corresponding to a product on the product list screen 710, the user terminal may transmit a product selection input to the server. The server may transmit a display command for a detailed information screen of a corresponding product based on receiving the product selection input. The user terminal may display the detailed information screen of the product. The user terminal may provide the country information of the product on the detailed information screen of the product. For example, as shown in FIG. 7, the user terminal may display a second portion 723 of the detailed information screen of the product based on detecting a swipe input 722 while displaying a first portion 721 of the detailed information screen of the product. The user terminal may display an area 724 indicating the country information of the product in the second portion 723.

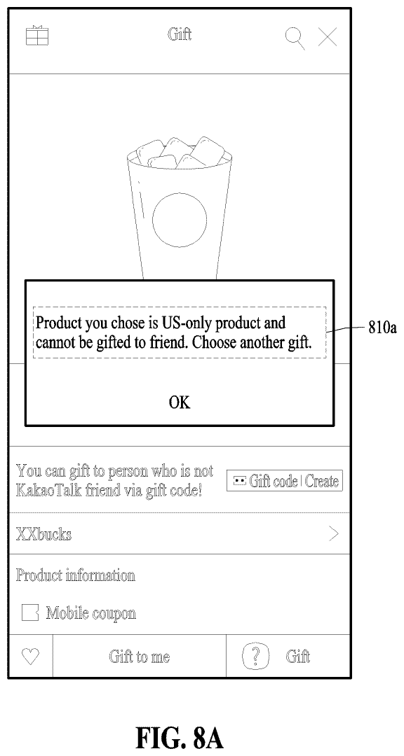

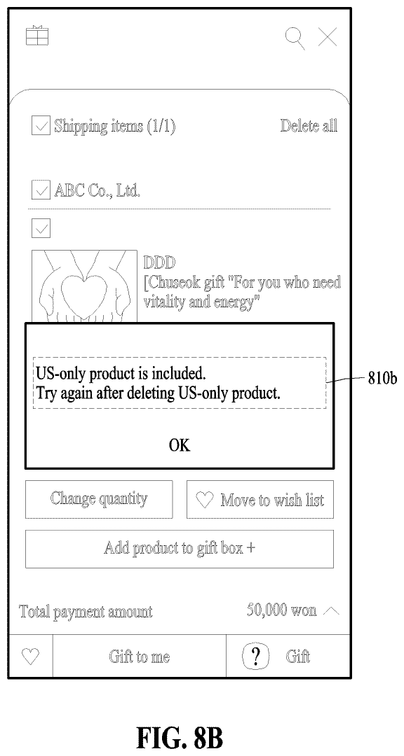

FIGS. 8A and 8B are diagrams illustrating an example of an operation in which an electronic device compares country information of a target product to country information of a plurality of user accounts, according to various embodiments.

A server (e.g., the server 120 of FIG. 1) according to an embodiment may compare the country information of the target product designated by a product designation input to the country information of the plurality of user accounts designated by a recipient designation input, and may determine whether to allow gifting based on a comparison result.

The server may receive, from a user terminal, the product designation input designating a product to be gifted. For example, the user terminal may detect a user input designating a corresponding product as the product to be gifted on a product detail screen (e.g., the first portion 721 of the product detail screen of FIG. 7 and the second portion 723 of the product detail screen of FIG. 7). When detecting the user input designating a product, the user terminal may transmit the product designation input to the server. The server may receive the product designation input from the user terminal.

The server may compare the country information of the target product designated by the product designation input to the country information of the plurality of user accounts, based on receiving the recipient designation input and the product designation input. The target product may refer to the product designated by the product designation input. Country information of a product may include information indicating a country in which the product is available.

According to an embodiment, the server may compare the country information of the target product to the country information indicating the target country.

For example, the server may allow gifting the target product to a recipient account based on the country information of the target product indicating the target country. As described above with reference to FIG. 2, the server may request payment for the target product from the user terminal, and the user terminal may make payment for the target product. Consequently, gifting the target product from a purchaser account to the recipient account may be completed.

In another example, the server may transmit, to the user terminal, a display command for a notification message informing that the target product is not available in the target country, based on the country information of the target product indicating a country other than the target country. The user terminal may display a notification message (e.g., a notification message 810a and a notification message 810b) regarding the target product being unavailable in the target country.

For example, as shown in FIG. 8A, when the user terminal transmits the product designation input to the server through a detailed information screen for a single product, the user terminal may display the notification message 810a.

For example, as shown in FIG. 8B, the user terminal and/or the server may register one product or a plurality of products in a gift box (or a shopping cart). The user terminal may transmit, to the server, a product designation input designating the one product or the plurality of products registered in the gift box (or the shopping cart) as the product to be gifted. When country information of at least one product among product(s) designated by the product designation input indicates a country other than the target country, the server may display the notification message 810b.

According to an embodiment, the server may restrict gifting the target product to the recipient account based on the country information of the target product indicating a country other than the target country.

However, the server according to various embodiments of the present disclosure is not limited to restricting gifting the target product to the recipient account when the country information of the target product indicates a country other than the target country. For example, the server may allow gifting the target product when receiving an approval response from a recipient terminal accessing with the recipient account.

According to an embodiment, based on the country information of the target product indicating a different country from the target country, the server may transmit an approval request for receiving a gift of the target product available in the different country to the recipient terminal accessing with the recipient account. The server may allow gifting the target product to the recipient account based on receiving an approval response to the approval request from the recipient terminal. The server may restrict gifting the target product to the recipient account based on receiving a rejection response to the approval request from the recipient terminal.

In one embodiment, the server can service receiving of product available in another country when the recipient intends to use the products in the other country, even if the recipient account is a user account of the target country, by receiving an approval response and/or a rejection response for receiving the target products from the other country from the recipient account.

FIG. 9 is a drawing illustrating an example of a lookup screen for information on a target product gifted to a recipient account, according to various embodiments.

A server (e.g., the server 120 of FIG. 1) according to an embodiment may transmit a display command for a lookup screen 900 for information on the target product to a recipient terminal accessing with a recipient account. The recipient terminal may display the lookup screen 900 for information on the target product. The recipient terminal may display at least one of a price of the target product, an image of the target product, or a brand of the target product in the lookup screen 900 for information on the target product. The recipient terminal may display a graphic object 910 corresponding to country information of the target product in the lookup screen 900 for information on the target product. The graphic object 910 may represent a country in which the target product is available.

The examples described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described examples, or vice versa.

As used herein, each of “A or B,” “at least one of A and B,” “at least one of A or B,” “A, B, or C,” “at least one of A, B, and C,” “at least one of A, B, or C,” “one or a combination or two or more of A, B, and C,” and the like may include any one of the items listed together in the corresponding one of the phrases, or all possible combinations thereof.

Although the examples have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by a server, the method comprising:
receiving, from a user terminal accessing a purchaser account, a recipient designation input designating a plurality of user accounts as a recipient of a gift from the user terminal;
determining, based on country information of the plurality of user accounts indicating a plurality of countries, a target country from among the plurality of countries;
determining, from among the plurality of user accounts, a user account having country information indicating the determined target country as a recipient account; and
transmitting, to the user terminal, a display command for a screen that provides information of a product giftable to the determined recipient account.

2. The method of claim 1, wherein the determining of the target country from among the plurality of countries comprises:
determining, based on the plurality of countries comprising a plurality of candidate countries available for a gift service, the target country from among the plurality of candidate countries by using a priority of the plurality of candidate countries.

3. The method of claim 1, wherein the determining of the target country from among the plurality of countries comprises:
determining, based on the plurality of countries comprising first countries available for a gift service and a second country unavailable for the gift service, the target country from among the first countries,
wherein the method further comprises:
transmitting, to the user terminal, a display command for a partial gifting enabled message notifying that, among a plurality of user accounts, gifting to a user account of the first countries is possible and gifting to a user account of the second country is not possible.

4. The method of claim 1, further comprising:
skipping the determining of the target country, the determining of the recipient account, and the transmitting of the display command, based on a determination that all of the plurality of countries being unavailable for a gift service; and
transmitting, to the user terminal, a display command for a gifting impossible message indicating that gifting to the plurality of user accounts is not possible.

5. The method of claim 1, wherein the transmitting of the display command for the screen to the user terminal comprises:
transmitting the display command for the screen comprising information of a product available in the target country to the user terminal; and
excluding information of a product available in a country other than the target country from the screen.

6. The method of claim 1, further comprising:
determining whether the plurality of countries comprises another country available for a gift service, based on completion of gifting from the purchaser account to the recipient account;
changing the target country to the other country based on the plurality of countries including the other country in which the gift service is available; and
repeating the determining of the user account as the recipient account and the transmitting of the display command, based on the changed target country.

7. The method of claim 1, further comprising:
receiving, from the user terminal, a product designation input designating a product to be gifted; and
comparing country information of a target product designated by the product designation input to the country information of the plurality of user accounts, based on receiving the recipient designation input and the product designation input.

8. The method of claim 7, further comprising:
allowing gifting the target product to the recipient account based on the country information of the target product indicating the target country; and
transmitting, to the user terminal, a display command for a notification message informing that the target product is not available in the target country, based on the country information of the target product indicating a country other than the target country.

9. The method of claim 8, further comprising:
restricting gifting the target product to the recipient account based on the country information of the target product indicating a country other than the target country.

10. The method of claim 8, further comprising:
transmitting, based on the country information of the target product indicating a different country from the target country, an approval request for receiving a gift of the target product available in the different country to a recipient terminal accessing the recipient account;
allowing gifting the target product to the recipient account based on receiving an approval response to the approval request from the recipient terminal; and
restricting gifting the target product to the recipient account based on receiving a rejection response to the approval request from the recipient terminal.

11. A non-transitory computer-readable storage medium storing instructions that, when executed by one or more processors, cause the one or more processors to perform the method of claim 1.

12. A server comprising:
one or more processors; and
a memory configured to store instructions,
wherein the instructions, when executed by the one or more processors, cause the server to:
receive a recipient designation input designating a plurality of user accounts as a recipient of a gift from a user terminal accessing a purchaser account;
determine, based on country information of the plurality of user accounts indicating a plurality of countries, a target country from among the plurality of countries;
determine, from among the plurality of user accounts, a user account having country information indicating the determined target country as a recipient account; and
transmit, to the user terminal, a display command for a screen that provides information of a product giftable to the determined recipient account.

13. The server of claim 12, wherein the instructions, when executed by the one or more processors, cause the server to:
determine, based on the plurality of countries comprising a plurality of candidate countries available for a gift service, the target country from among the plurality of candidate countries by using a priority of the plurality of candidate countries.

14. The server of claim 12, wherein the instructions, when executed by the one or more processors, cause the server to:
determine, based on the plurality of countries comprising first countries available for a gift service and a second country unavailable for the gift service, the target country from among the first countries; and
transmit, to the user terminal, a display command for a partial gifting enabled message notifying that, among a plurality of user accounts, gifting to a user account of the first countries is possible and gifting to a user account of the second country is not possible.

15. The server of claim 12, wherein the instructions, when executed by the one or more processors, cause the server to:
skip the determining of the target country, the determining of the recipient account, and the transmitting of the display command, based on a determination that all of the plurality of countries being unavailable for a gift service; and
transmit, to the user terminal, a display command for a gifting impossible message indicating that gifting to the plurality of user accounts is not possible.

16. The server of claim 12, wherein the instructions, when executed by the one or more processors, cause the server to:
transmit the display command for the screen comprising information of a product available in the target country to the user terminal; and
exclude information of a product available in a country other than the target country from the screen.

17. The server of claim 12, wherein the instructions, when executed by the one or more processors, cause the server to:
receive, from the user terminal, a product designation input designating a product to be gifted; and
compare country information of a target product designated by the product designation input to the country information of the plurality of user accounts, based on receiving the recipient designation input and the product designation input.

18. The server of claim 17, wherein the instructions, when executed by the one or more processors, cause the server to:
allow gifting the target product to the recipient account based on the country information of the target product indicating the target country; and
transmit, to the user terminal, a display command for a notification message informing that the target product is not available in the target country, based on the country information of the target product indicating a country other than the target country.

19. The server of claim 18, wherein the instructions, when executed by the one or more processors, cause the server to:
restrict gifting the target product to the recipient account based on the country information of the target product indicating a country other than the target country.

20. The server of claim 18, wherein the instructions, when executed by the one or more processors, cause the server to:
transmit, based on the country information of the target product indicating a different country from the target country, an approval request for receiving a gift of the target product available in the different country to a recipient terminal accessing the recipient account;
allow gifting the target product to the recipient account based on receiving an approval response to the approval request from the recipient terminal; and
restrict gifting the target product to the recipient account based on receiving a rejection response to the approval request from the recipient terminal
